(19) United States
(12) Patent Application Publication
(10) Pub. No.: US 2024/0045028 A1
(43) Pub. Date: Feb. 8, 2024

(54) LIDAR DETECTION METHOD AND DETECTION APPARATUS

(71) Applicant: SUTENG INNOVATION TECHNOLOGY CO., LTD., Shenzhen (CN)

(72) Inventor: Huazhou CHEN, Shenzhen (CN)

(73) Assignee: SUTENG INNOVATION TECHNOLOGY CO., LTD., Shenzhen (CN)

(21) Appl. No.: 18/223,532

(22) Filed: Jul. 18, 2023

(30) Foreign Application Priority Data
Jul. 26, 2022 (CN) 202210886295.1

(51) Int. Cl. G01S 7/481; G01S 7/48; G01S 7/4865; G01S 17/88; G02B 3/00; G02B 27/30

(52) U.S. Cl. CPC G01S 7/4811; G01S 7/4802; G01S 7/4865; G01S 7/4817; G01S 17/88; G02B 3/005; G02B 27/30

(57) ABSTRACT

This application provides a detection method and a LiDAR detection apparatus. The detection method includes: outputting detection laser beams with a preset time delay between two adjacent emissions; receiving the detection laser beam and emitting the detection laser beam to a preset region, scanning the preset region in a preset scanning mode, and further receiving an echo laser beam reflected from the preset region, and outputting the echo laser beam; receiving the echo laser beam and converting the echo laser beam into an electrical signal; and collecting the electrical signal, and processing the electrical signal to obtain detection information of the preset region.

### CROSS-REFERENCE TO RELATED APPLICATION

The present application claims the benefit of priority to Chinese Patent Application No. 202210886295.1, filed on Jul. 26, 2022, which is hereby incorporated by reference in its entirety.

### TECHNICAL FIELD

This application relates to the technical field of LiDAR detection, and in particular, to a LiDAR detection method and detection apparatus.

### BACKGROUND

Currently, LiDARs are used in fields such as smart transportation, autonomous driving, assisted driving, navigation, surveying and mapping, meteorology, aviation, or robotics. However, a scanning module of a conventional semi-solid LiDAR emits each frame of detection light after a scanning working mode of the LiDAR is determined, and as a result, the LiDAR can only use fixed scanning resolution for the same scanning region, resulting in poor laser scanning flexibility and insufficient scanning resolution of the LiDAR, which renders the LiDAR unable to satisfy detection requirements in different application scenarios.

For different application scenarios, LiDARs have problems of insufficient scanning resolution and insufficient detection capability in various application scenarios.

### SUMMARY

Embodiments of this application provide a LiDAR detection method and detection apparatus, which resolves a problem of insufficient detection capability caused by insufficient scanning resolution of LiDAR in various application scenarios.

A first aspect of the embodiments of this application provides a LiDAR detection method, including: outputting, by an emission module, two adjacent detection laser beams as per preset time delay; receiving, by a scanning module, the detection laser beams and emitting the detection laser beams to a preset region, scanning, by the scanning module, the preset region in a preset scanning mode, and further receiving, by the scanning module, an echo laser beam reflected from the preset region, and outputting the echo laser beam; receiving, by a receiving and detection module, the echo laser beam and converting the echo laser beam into an electrical signal; and collecting, by a signal collection and processing module, the electrical signal, and processing the electrical signal to obtain detection information of the preset region.

In some embodiments, a scanning direction of the scanning module includes at least one scanning direction in a first scanning direction and a second scanning direction, the first scanning direction and the second scanning direction form a preset angle, and the preset angle is less than or equal to 180 degrees; and scanning, by the scanning module, the preset region in a preset scanning mode further includes: scanning, by the scanning module, the preset region in the first scanning direction in the preset scanning mode corresponding to the preset region; or scanning, by the scanning module, the preset region in the second scanning direction in the preset scanning mode corresponding to the preset region.

In some embodiments, the preset region includes at least one preset sub-region; and before outputting, by an emission module, two adjacent detection laser beams as per preset time delay, the detection method includes: obtaining, by the LiDAR, a scanning region corresponding to a detection angle of view of the scanning module; obtaining, by the LiDAR, a preset sub-region in which the scanning region is located; obtaining, by the LiDAR, scanning density corresponding to the preset sub-region; and based on the scanning density, controlling, by the LiDAR, the emission module to output a detection laser beam as per preset time delay corresponding to the scanning density.

In some embodiments, scanning, by the scanning module, the preset region in a preset scanning mode includes: obtaining, by the scanning module, the preset scanning mode corresponding to the scanning density; and scanning, by the scanning module, the preset sub-region in the preset scanning mode.

In some embodiments, the preset scanning mode is to scan the preset sub-region by using an inter-group interval of scanning groups corresponding to the preset sub-region, the scanning group is N scanning lines formed by detection laser beams emitted by the emission module at a time, and the inter-group interval is an inter-group angle interval between scanning groups during two adjacent emissions; and
a formula for calculating the inter-group interval is:

δβ=N/nδθ
where δβ is the inter-group interval;
δθ is an angle interval between scanning lines in the scanning group;
N is the number of scanning lines in each scanning group, and N is an integer; and
n is a densification multiple of the scanning line corresponding to the preset sub-region, n is a real number and n is greater than or equal to 0.

In some embodiments, the preset scanning mode is also to scan the preset sub-region at a scanning speed of scanning groups corresponding to the preset sub-region, and determine the scanning speed corresponding to the preset sub-region based on the preset time delay, the inter-group interval, and both the preset time delay and the inter-group interval, where the scanning group is N scanning lines formed by detection laser beams emitted by the emission module at a time, N is an integer, and the inter-group interval is an inter-group angle interval between scanning groups during two adjacent emissions.

In some embodiments, a formula for calculating the inter-group interval further is:

$$δβ = \frac{{α}_{period} - {α}_{FOV}}{{ω}_{2}} {ω}_{1}$$

where δβ is the inter-group interval;
α_{period} is a scanning angle of the scanning group in one scanning period in the second scanning direction;
α_{FOV} is a detection angle of view in the second scanning direction, and α_{period} is greater than α_{FOV};
ω₁ is a first scanning speed in the first scanning direction; and
ω₂ is a second scanning speed in the second scanning direction.

In some embodiments, the emission module includes at least one emission group; and outputting, by an emission module, two adjacent detection laser beams as per preset time delay includes: outputting, by the same emission group of the emission module, two adjacent detection laser beams as per the preset time delay; or outputting, by each emission group of the emission module, two adjacent detection laser beams as per the preset time delay.

According to a second aspect, embodiments of this application provide a LiDAR detection apparatus, including: an emission module, configured to output two adjacent detection laser beams as per preset time delay; an emission optical path module, configured to receive the detection laser beam and output the detection laser beam; a scanning module, configured to receive the detection laser beam and emit the detection laser beam to a preset region, scan the preset region in a preset scanning mode corresponding to the preset region, and further receive an echo laser beam reflected from the preset region and output the echo laser beam; a receiving and detection module, configured to receive the echo laser beam and convert the echo laser beam into an electrical signal; and a signal collection and processing module, configured to collect the electrical signal, and process the electrical signal to obtain detection information of the preset region.

In some embodiments, the emission optical path module includes a first lens, a second lens and a third lens that are coaxial; the first lens receives the detection laser beam output by the emission module, and converts a detection laser beam in a horizontal light emission direction in the detection laser beams into collimated light; the second lens receives the collimated light and transmits the collimated light to the third lens, and the second lens also refracts a detection laser beam in a vertical light emission direction in the detection laser beams to the third lens; the third lens receives the collimated light and transmits the collimated light to the scanning module, and the third lens also converts a detection laser beam in the vertical light emission direction in the detection laser beams into the collimated light and transmits the collimated light to the scanning module; the second lens and the third lens form a telephoto optical path; and equivalent focal length of the telephoto optical path is greater than or equal to 50 mm.

For beneficial effects of the foregoing second aspect, refer to relevant description in the first aspect.

Based on the LiDAR detection method and detection apparatus provided in the embodiments of this application, the emission module outputs two adjacent detection laser beams as per the preset time delay; the preset region is scanned based on different application scenarios in the preset scanning mode corresponding to the preset region; the scanning module also receives the echo laser beam reflected from the preset region and outputs the echo laser beam; the receiving and detection module receives the echo laser beam and converts the echo laser beam into an electrical signal; and the signal collection and processing module collects the electrical signal, and processes the electrical signal to obtain detection information of the preset region, to obtain a scanning point cloud of high density in the preset region and obtain more point cloud detection information, thereby improving scanning resolution of the LiDAR for the preset region, improving scanning flexibility of the LiDAR for different preset regions, and further improving detection capabilities of the LiDAR in different application scenarios.

### BRIEF DESCRIPTION OF DRAWINGS

To explain the technical solution in embodiments in this application, the following briefly introduces the accompanying drawings. Obviously, the accompanying drawings in the following description are only some embodiments in this application.

FIG. 1 is a flowchart of a LiDAR detection method according to some embodiments of this application;

FIG. 2 is a schematic diagram of a scanning mode of a fixed step size of a LiDAR according to some embodiments of this application;

FIG. 3 is a flowchart of a detection method before the emission module outputs two adjacent detection laser beams as per the preset time delay according to some embodiments of this application;

FIG. 4 is a flowchart indicating that a scanning module scans a preset region in a preset scanning mode corresponding to the preset region according to some embodiments of this application;

FIG. 5 is a schematic diagram indicating that a scanning module obtains a preset scanning mode corresponding to scanning density according to some embodiments of this application;

FIG. 6-1 is a schematic diagram of arrangement of an emitter on an emission board according to some embodiments of this application;

FIG. 6-2 is a schematic diagram of arrangement of an emitter on an emission board according to some embodiments of this application;

FIG. 7-1 is a schematic diagram of a cross section of an irregular rotating mirror according to some embodiments of this application;

FIG. 7-2 is a schematic diagram of an angle of view of an irregular rotating mirror according to some embodiments of this application;

FIG. 7-3 is a schematic diagram of a cross section of a regular rotating mirror according to some embodiments of this application;

FIG. 7-4 is a schematic diagram of an angle of view of a regular rotating mirror according to some embodiments of this application;

FIG. 8 is a flowchart indicating that a scanning module receives a detection laser beam and emits the detection laser beam to a preset region, and the scanning module scans the preset region in a preset scanning mode corresponding to the preset region according to some embodiments of this application;

FIG. 9 is another flowchart indicating that a scanning module receives a detection laser beam and emits the detection laser beam to a preset region, and the scanning module scans the preset region in a preset scanning mode corresponding to the preset region according to some embodiments of this application;

FIG. 10 is a schematic structural diagram of a LiDAR according to some embodiments of this application;

FIG. 11 is a schematic structural diagram of an emission optical path module of a LiDAR according to some embodiments of this application; and

FIG. 12 is a schematic structural diagram of a scanning module of a LiDAR according to some embodiments of this application.

### DETAILED DESCRIPTION

For the purpose of illustration rather than limitation, the following describes details such as a system structure and technology, to facilitate a thorough understanding of the embodiments of this application. In other cases, detailed descriptions of well-known systems, modules, circuits, and methods are omitted, to prevent unnecessary details from causing distraction from the description of this application.

When used in this specification and appended claims of this application, a term “include” indicates existence of a described feature, entirety, a step, an operation, an element and/or a component, but does not exclude existence or addition of one or more other features, entireties, steps, operations, elements, components and/or a collection thereof.

The term “and/or” used in this specification and appended claims of this application refers to any combination of one or more of the associated items listed and all possible combinations thereof, and inclusion of these combinations.

In addition, in the descriptions of this specification and the appended claims of this application, the terms “first,” “second,” “third,” and the like are merely intended for differential description, and should not be understood as any indication or implication of relative importance.

Reference to “an embodiment,” “some embodiments,” or the like described in this specification of this application means that one or more embodiments of this application include a feature, structure, or characteristic described with reference to the embodiments. Therefore, expressions such as “in an embodiment,” “in some embodiments,” “in some other embodiments,” and “in some additional embodiments” appearing in different places in this specification do not necessarily indicate reference to the same embodiment, but mean “one or more but not all embodiments,” unless otherwise specified in another way. The terms “include,” “comprise,” “have,” and variants thereof all mean “including but not limited to,” unless otherwise specified in another way.

Technical solutions of this application are described below through embodiments.

Because LiDARs need to adapt to various application scenarios, the ranging limit of existing various LiDARs is about 200 m (with 10% reflectivity), and the numbers of lines are mainly 128. For different application scenarios, a scanning module of a conventional semi-solid LiDAR emits each frame of detection light after a scanning working mode of the LiDAR is determined, and as a result, the LiDAR can only use fixed scanning resolution for the same region, resulting in poor laser scanning flexibility and insufficient scanning resolution of the LiDAR, which renders the LiDAR unable to satisfy detection requirements in different application scenarios or sufficiently detect a surrounding environment, thereby requiring further improvement of detection capabilities of the LiDAR in different application scenarios.

To resolve problems of insufficient scanning resolution and insufficient detection capabilities of the LiDAR in various application scenarios, in the detection method in the embodiments of this application, the emission module outputs two adjacent detection laser beams as per the preset time delay; the preset region is scanned based on different application scenarios in the preset scanning mode corresponding to the preset region; the scanning module also receives the echo laser beam reflected from the preset region and outputs the echo laser beam; the receiving and detection module receives the echo laser beam and converts the echo laser beam into an electrical signal; and the signal collection and processing module collects the electrical signal, and processes the electrical signal to obtain detection information of the preset region, to obtain a scanning point cloud of high density in the preset region and obtain more point cloud detection information, thereby improving scanning resolution of the LiDAR for each preset region, improving scanning flexibility of the LiDAR for different preset regions, and further improving detection capabilities of the LiDAR in different application scenarios.

The preset region is a region corresponding to the detection field of view of the LiDAR, and the preset region of laser scanning may also be referred to as the detection field of view (FOV), which refers to a scanning range that the LiDAR can cover. Scanning directions of the scanning module include a first scanning direction and a second scanning direction, the first scanning direction and the second scanning direction form a preset angle, the preset angle is less than or equal to 180 degrees, and scanning in the two scanning directions is individually controlled. For example, the first scanning direction is used for vertical scanning (also referred to as column scanning) relative to a vertical direction of a target object, the second scanning direction is used for horizontal scanning (also referred to as row scanning) relative to a horizontal direction of the target object in the preset region, and in this case, the preset angle formed by the first scanning direction and the second scanning direction is 90°. The preset angle formed by two scanning directions may be set based on the need of the LiDAR. For example, the preset angle can also be 30°, 60°, 120°, and 150°.

The scanning apparatus in the first direction may be, for example, a rotating mirror, a one-dimensional galvanometer, or any scanning apparatus in a rotating platform. A scanning apparatus in the second direction can also be, for example, a rotating mirror, a one-dimensional galvanometer, or any scanning apparatus in a rotating platform. A type of scanning apparatus in any scanning direction in the two scanning directions is not limited in this application. Types of the scanning apparatus in the first scanning direction and the scanning apparatus in the second scanning direction may be the same or different. In some embodiments, the scanning apparatuses in the two scanning directions can be individually controlled.

A region of interest (ROI) refers to a region that needs to be focused on in the preset region during laser scanning. In some embodiments, the preset region may include at least one preset sub-region, the preset region may include multiple preset sub-regions. For example, the preset region includes at least two preset sub-regions. For example, there may be 2, 3, 4, or 5 preset sub-regions, and the number of preset sub-regions included in the preset region is not limited in embodiments of this application. Some of the multiple preset sub-regions may be located in the region of interest of the LiDAR, and some others are located in another region of the LiDAR other than the region of interest, that is, the general detection region.

The region of interest is a region on which the LiDAR focuses, and users can set the target detection based on their respective needs. Generally, higher scanning resolution is required for the region of interest, and corresponding scanning lines are denser, that is, scanning density is higher. In addition, lower scanning resolution is required for another region (general detection region) in the detection field of view of the LiDAR other than the region of interest, corresponding scanning lines are sparser, that is, scanning density is lower.

An angle range of the detection angle of view corresponding to the preset region of the LiDAR includes an angle range of a horizontal detection angle of view and an angle range of the vertical detection angle of view, the vertical detection angle of view corresponds to vertical scanning (also referred to as column scanning) relative to a vertical direction of the target object, and the horizontal detection angle of view corresponds to horizontal scanning (also referred to as row scanning) relative to a horizontal direction of the target object.

In some embodiments, the angle range of the horizontal detection angle of view in the detection angle of view of the LiDAR is −60° to 60°, and the angle range of the vertical detection angle of view in the detection angle of view of the LiDAR is −12.5° to 12.5°. In some embodiments, there is no specific limitation on upper and lower limits of the angle range. For example, the angle range of the horizontal detection angle of view in the detection angle of view can also be various angle ranges such as −30° to 30°, −45° to 45° and −75° to 75°, the angle range of the vertical detection angle of view in the detection angle of view can also be various angle ranges such as −10° to 10°, −15° to 15°, −20° to 20° and −30° to 30°. The upper and lower limits of the angle range are set based on the maximum possible detection range of the scanning module of the LiDAR.

The angle of view corresponding to one entire scan completed by the scanning module is greater than or equal to the total detection angle of view of the LiDAR. In addition, an angle of view corresponding to each step of the scanning module of the LiDAR is less than or equal to the total detection angle of view of the LiDAR, and a specific angle range of the angle of view corresponding to each step of the scanning module is set based on a specific requirement of the scanning resolution of the scanning module.

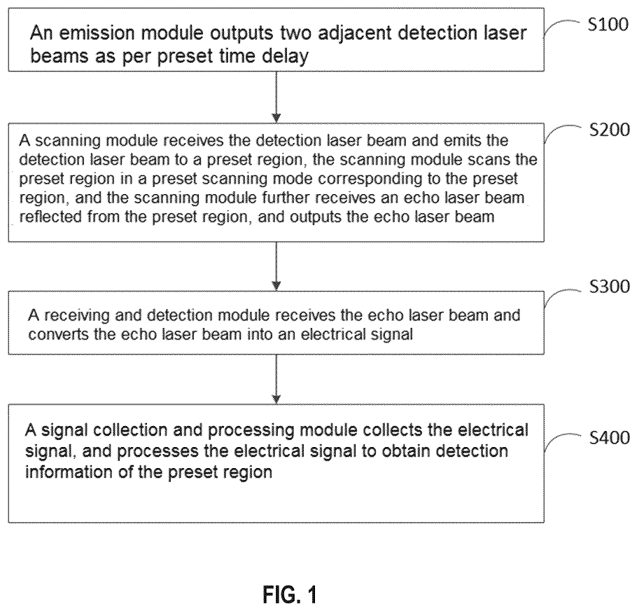

As shown in FIG. 1, a first aspect of the embodiments of this application provides a LiDAR detection method, including the following step.

S100. An emission module outputs two adjacent detection laser beams as per preset time delay.

In some embodiments, the emission module includes at least one emission group, that is, the emission module can include one or more emission groups, and outputting, by an emission module, two adjacent detection laser beams as per preset time delay includes:

outputting, by the same emission group of the emission module, two adjacent detection laser beams as per the preset time delay; or outputting, by each emission group of the emission module, two adjacent detection laser beams as per the preset time delay.

The preset time delay is a time interval between two adjacent emitted detection laser beams of the same emission group, or the preset time delay is a corresponding time interval between two adjacent emitted detection laser beams of different emission groups.

Because the same emission group outputs two adjacent detection laser beams as per the preset time delay, or each emission group outputs two adjacent detection laser beams as per the preset time delay, in this way, scanning resolution of the LiDAR can be adjusted based on a scanning resolution requirement for the LiDAR by controlling time of the two adjacent emissions of the emission module and a scanning step size of the scanning module. When the same preset time delay is set, the emission module includes multiple emission groups, and detection laser beam scanning lines emitted to the preset region each time are denser, to obtain more echo laser beams from the preset region, further obtain a scanning point cloud of higher density for the preset region, and obtain more point cloud detection information, thereby improving the scanning resolution of the LiDAR with respect to the preset region, improving scanning flexibility of the LiDAR with respect to different preset regions, and improving the detection capabilities of the LiDAR in different application scenarios. The number of emission groups of the emission module and the number of lasers included in each emission group are not specifically limited in embodiments of this application, and are set based on a detection performance requirement for the LiDAR.

In some embodiments, the emission group includes an emitter, the emitter may be a vertical-cavity surface-emitting laser (VCSEL) or an edge emitting laser (EEL), or a fiber laser emits light, and an outgoing array is formed in a specific light splitting method. Multiple emission groups can be arranged in one or more columns. In some embodiments, physical interval between the lasers in the multiple emission groups in a transverse direction and a longitudinal direction may be equal or unequal. A physical interval between lasers is set based on the scanning requirement for the LiDAR.

In some embodiments, the emission module outputs the two adjacent detection laser beams as per the preset time delay, that is, after outputting the detection laser beam once, the emission module then outputs the detection laser beam again after a time interval, namely, the preset time delay T₀. In addition, the detection laser beams emitted each time form one scanning group, and the scanning group is N scanning lines formed by the detection laser beams emitted by the emission module at a time, where N is an integer. In addition, the inter-group angle interval between scanning groups during two adjacent emissions of the emission module is also referred to as an inter-group interval. In some embodiments, when the LiDAR has two scanning directions, the interval between the scanning lines can be implemented by a scanning apparatus by performing scanning in one dimension. The inter-group interval is also referred to as the step size of the scanning apparatus.

In some embodiments, when the emission module is controlled to output the detection laser beam as per the preset time delay T₀, power of outputting the detection laser beam by the emission module within the preset time delay T₀ can be changed for outputting based on a scanning requirement for the LiDAR, or maintained constant for outputting. In some embodiments, power of outputting the detection laser beam by the one or more emission groups within the preset time delay T₀ can be maintained constant for outputting.

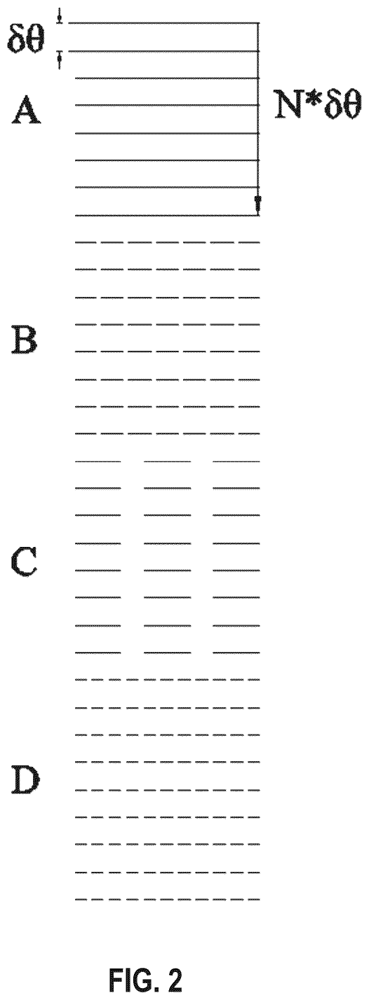

As shown in FIG. 2, when the emission module outputs two adjacent detection laser beams at a fixed time interval, the same line type in the figure indicates that 8 detection laser beam scanning lines output by the emission module of the LiDAR at a time form a scanning group, and 4 line types indicate that the emission module outputs four groups of detection laser beams A, B, C, and D in sequence. The scanning group scans in the vertical direction in a fixed scanning mode (that is, a fixed scanning speed and a fixed scanning step size). The number of scanning lines in each scanning group is 8, and an angle interval between the scanning lines is δθ. At moment t1, the scanning group A outputs a group A of 8 detection laser beam scanning lines at fixed frequency to scan from top to bottom, and the scanning module continues to scan downwards at a fixed step size of 8×δθ; at moment t2 when the scanning module completes the fixed step size of 8×δθ, the scanning group B outputs a group B of 8 detection laser beam scanning lines at fixed frequency to continue scanning from top to bottom; and at moment t3 when the scanning module completes the fixed step size of 8×δθ, the scanning group C outputs a group C of 8 detection laser beam scanning lines at fixed frequency to continue scanning from top to bottom until the entire spatial region is scanned, and a scanning line with resolution of δθ is formed in the entire space. Either time delay of the scanning module from the moment t1 to the moment t2 of completing the fixed step size of 8×δθ or time delay of the scanning module from the moment t2 to the moment t3 of completing the fixed step size of 8×δθ is fixed time delay T. When the emission module uses a fixed time interval and the scanning module scans in a fixed scanning mode, a scanning field of view with uniform scanning density can be formed.

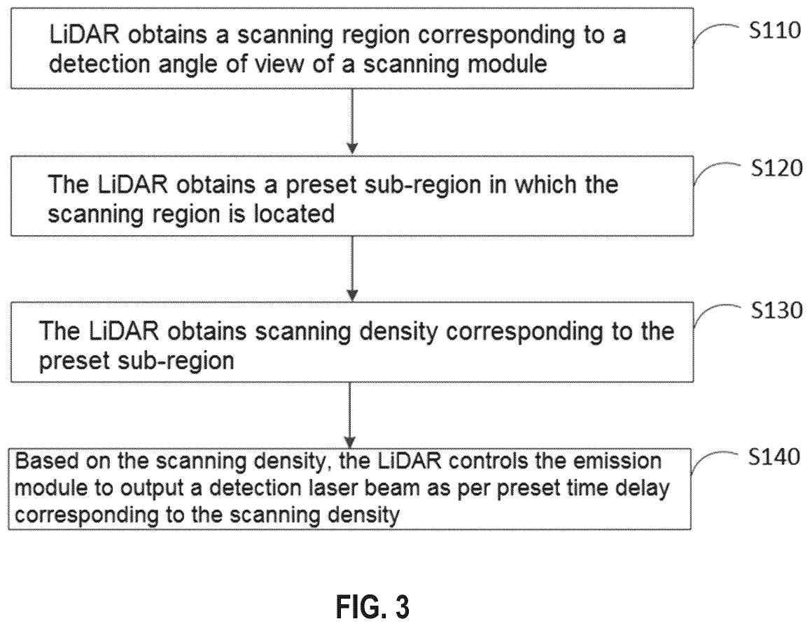

In some embodiments, when the preset region includes at least one preset sub-region, that is, the preset region includes one or more preset sub-regions, and the preset sub-regions have different scanning densities, that is, the scanning field of view is non-uniform, as shown in FIG. 3, before outputting, by an emission module, two adjacent detection laser beams as per preset time delay, the detection method further includes the following steps.

S110. A LiDAR obtains a scanning region corresponding to a detection angle of view of a scanning module.

S120. The LiDAR obtains a preset sub-region in which the scanning region is located.

S130. The LiDAR obtains scanning density corresponding to the preset sub-region.

S140. Based on the scanning density, the LiDAR controls the emission module to output a detection laser beam as per preset time delay corresponding to the scanning density.

Because the preset region includes at least one preset sub-region, before the scanning module outputs the detection laser beam, the LiDAR first obtains the scanning region corresponding to the detection angle of view of the scanning module, then obtains, based on the scanning region, a preset sub-region in the total detection field of view of the LiDAR in which the scanning region is located, and obtains the scanning density corresponding to the preset sub-region, so that the LiDAR controls, based on the obtained scanning density in the preset sub-region, the emission module to output a detection laser beam as per the preset time delay corresponding to the scanning density of the preset sub-region. Therefore, based on the scanning density required for the scanning resolution of the preset sub-region, the LiDAR scans the preset sub-region by using the preset time delay corresponding to the scanning density of the preset sub-region, thereby improving flexibility of the preset scanning region of the LiDAR. For multiple preset sub-regions in the preset region, the scanning densities in each preset sub-regions can be equal or unequal, some of the scanning densities of multiple preset sub-regions can be equal, and the scanning density of the preset sub-region is set based on the detection requirement for the LiDAR.

S200. A scanning module receives the detection laser beam and emits the detection laser beam to a preset region, the scanning module scans the preset region in a preset scanning mode corresponding to the preset region, and the scanning module further receives an echo laser beam reflected from the preset region, and outputs the echo laser beam.

The scanning module scans the preset region in the preset scanning mode corresponding to the preset region, and can scan in different preset scanning modes based on scanning resolution requirements for the preset region, which improves flexibility of using different scanning resolution for different preset regions by the LiDAR and improves the detection capabilities of the LiDAR in different application scenarios.

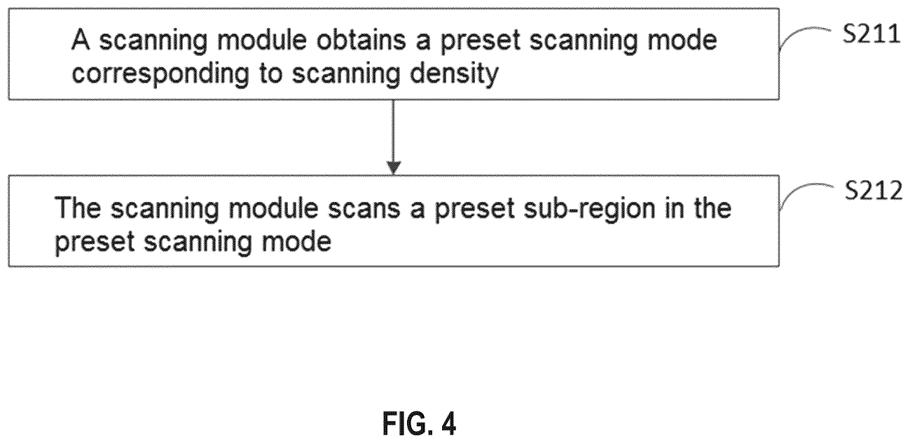

In some embodiments, as shown in FIG. 4, scanning, by the scanning module, the preset region in a preset scanning mode corresponding to the preset region includes the following step.

S210. The scanning module obtains the preset scanning mode corresponding to the scanning density.

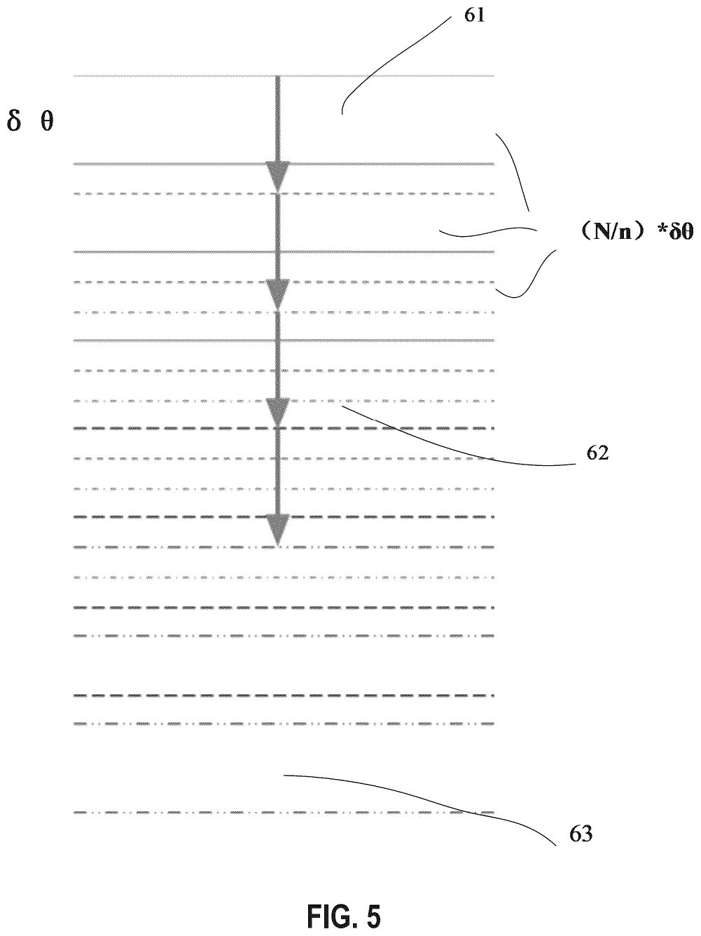

As shown in FIG. 5, because the scan density is characterized by an overlapping degree of scanning lines of scanning groups in the preset sub-region, for example, a preset sub-region 61 is formed by overlapping some scanning lines of the scanning group A and the scanning group B and the preset sub-region 63 is formed by overlapping some scanning lines of the scanning group C and the scanning group D, the scanning lines in the preset sub-region 61 and the preset sub-region 63 are relatively sparse and are at a low scanning density, the preset sub-region 62 is an overlapped region of the scanning groups A, B, C and D, and scanning lines in the preset sub-region 62 are relatively dense and are at a high scanning density. This indicates that the preset sub-region 62 is the region of interest, the preset sub-region 61 and the preset sub-region 63 are secondary regions of interest, and the scanning module obtains the preset scanning mode corresponding to a high scanning density, or obtains the preset scanning mode with a low scanning density.

In some embodiments, the scanning density is characterized by the number of scanning lines in the preset region, and the number of scanning lines in the preset region may be the number of scanning lines formed via overlapping of scanning lines of multiple scanning groups. A quotient of dividing the number X of scanning lines in the preset region by the number N of scanning lines of each emission group is calculated to obtain a scanning density in the preset region (that is, a point cloud densification multiple or a densification multiple of the scanning line in the preset region), where n=X/N.

S200. The scanning module scans the preset sub-region in the preset scanning mode.

The scanning module scans the preset sub-region in the preset scanning mode corresponding to the scanning density in the preset sub-region. Scanning is performed in a specific preset scanning mode based on the scanning density of each preset sub-region, which improves flexibility of controlling the scanning resolution of the LiDAR, thereby meeting requirements for different application scenarios.

In some embodiments, as shown in FIG. 5, after obtaining the preset scanning mode corresponding to the scanning density, the scanning module scans the preset sub-region 62 in the preset scanning mode with a high scanning density, and the scanning module scans the preset sub-regions 61 and 63 in the preset scanning mode with a low scanning density.

The higher the scanning density, the smaller the inter-group interval between the scanning groups, and the greater the stepping speed of the scanning module; or the lower the scanning density, the larger the inter-group interval between the scanning groups, and the smaller the stepping speed of the scanning module.

In some embodiments, the preset scanning mode is to scan the preset sub-region by using the inter-group interval between the scanning groups corresponding to the preset sub-region, and a formula for calculating the inter-group interval between the scanning groups is:

δβ=N/nδθ
where δβ is the inter-group interval;
δθ is an angle interval between scanning lines in the scanning group;
N is the number of scanning lines in each scanning group, and N is an integer; and
n is a densification multiple of the scanning line corresponding to the preset sub-region, n is an integer and n is greater than or equal to 0.

As shown in FIG. 2, because the number N of scanning lines of each scanning group satisfies N=8, an angle interval between scanning lines in the scanning groups is δθ, and each scanning group further emits an outgoing laser beam to perform next scanning after a previous scanning group completes scanning, a densification multiple n of the scanning lines corresponding to the preset sub-region satisfies n=1, then the inter-group interval between the scanning groups in the figure is δβ=8×δθ, and the preset sub-region in the figure is the general detection region.

As shown in FIG. 5, there are four scanning groups, and because the number N of scanning lines of each scanning group satisfies N=8, and an angle interval between scanning lines in the scanning groups is δθ, if a densification multiple n of the scanning lines corresponding to the preset sub-region 62 satisfies n=2, then the inter-group interval between the scanning groups in the figure is δβ=8/2δθ. The scanning density is improved by controlling matching between time of the two emissions of the emission module and the stepping size of the scanning module.

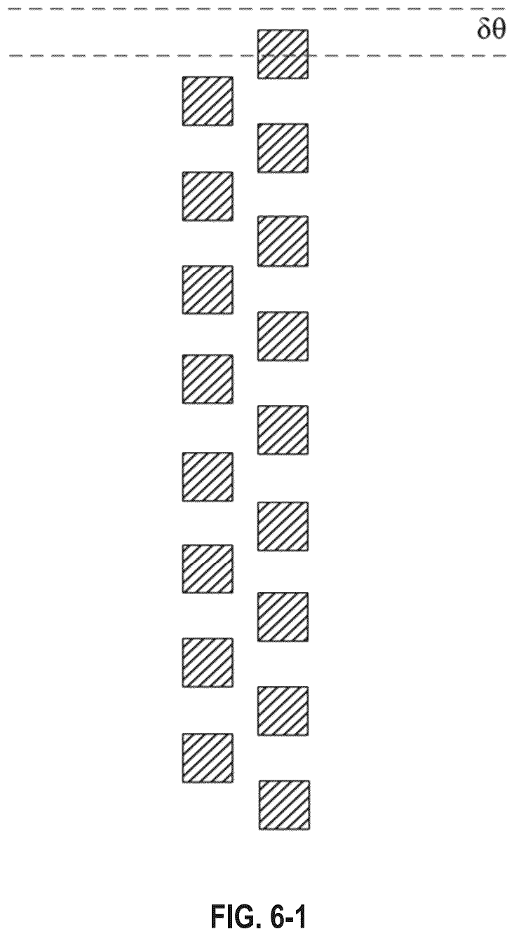

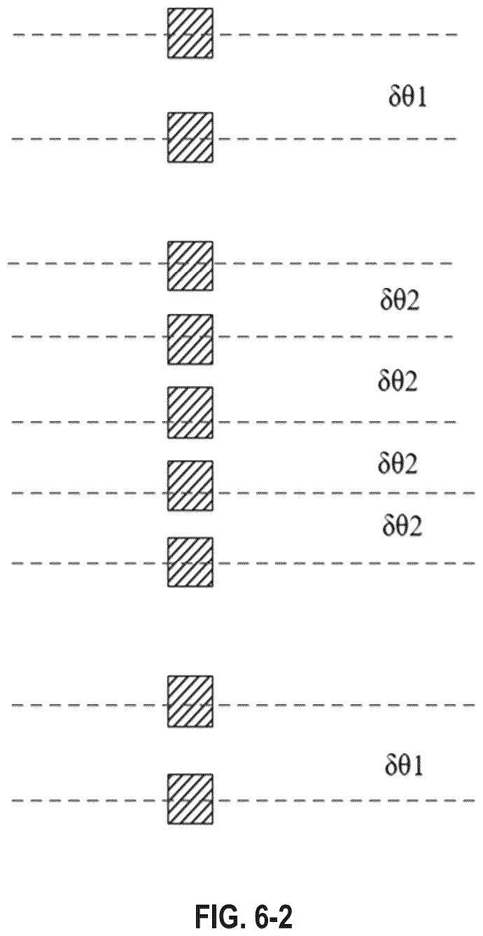

The angle interval δθ between the scanning lines in the scanning group can be implemented by setting an arrangement interval between emitters or by controlling emitting lasers to perform emission at intervals in some or all of the regions. The scanning line interval δθ herein may be implemented in a manner not limited to that in the foregoing description. The same emission group can be arranged in one column or different columns. When the same emission group is arranged in two columns, as shown in FIG. 6-1, δθ can be reduced by arranging all the emitters in the same emission group in a staggered manner; or δθ in a target region is reduced by arranging emitters in a staggered manner in a partial region. With such a design, the point cloud density in the target region can be further improved while a setting of the scanning apparatus remains unchanged. When the emitters in the same emission group are arranged in a column, the interval between the emitters at the edge and the interval between the emitters in the central region can also be set to be different, so that a point cloud in the target region is denser. As shown in FIG. 6-2, an interval between edge emitting laser (EEL) in the same emission group is 6611, and an interval between central emitting laser is 6612, where 6611>6612.

The scanning speed of the scanning module is determined by setting the preset time delay and the inter-group interval. When step sizes are the same, the longer the preset time delay, the greater the scanning speed; or the shorter the preset time delay, the smaller the scanning speed. When the scanning modules have the same step size, the smaller the scanning speed of the scanning module of the LiDAR, the higher the scanning resolution and the more obtained detection information; or the greater the scanning speed of the LiDAR, the lower the scanning resolution, and the less the obtained detection information.

In some embodiments, the preset scanning mode is also to scan the preset sub-region at the scanning speed of the scanning group corresponding to the preset sub-region, and preset regions can be graded based on scanning densities corresponding to the preset sub-regions, to determine the preset sub-regions as a target region of interest, a secondary region of interest or an ordinary region of interest. The scanning step size and step time of the scanning module are set based on the scanning densities of different preset sub-regions, and the scanning speeds of the scanning module are controlled in different regions. A scanning step size and step time of the scanning module in each level of region are set, so that the preset target sub-region of interest, the preset secondary sub-region of interest and the general detection region can be scanned at different scanning speeds. For example, the preset target sub-region of interest is scanned at an appropriate constant speed, scanning speeds are gradually increased for the preset secondary sub-region of interest and the general detection region, and therefore, the preset sub-region of interest can be scanned at multiple scanning speeds, so that a detection situation of the region of interest can be obtained to the maximum extent, thereby improving the detection efficiency of the LiDAR.

Because the scanning directions of the scanning module include the first scanning direction (that is, the vertical scanning direction) and the second scanning direction (that is, the horizontal scanning direction), a scanning period is to complete both scanning of the entire horizontal detection field of view and vertical detection field of view. When the scanning apparatus in the first direction is used as an apparatus for implementing the step size, the scanning period for completing one scan can be controlled by controlling the scanning time of the scanning apparatus in the second direction, and the scanning period for one scan is also equal to the preset time delay between two emissions, and is also equal to the time for the scanning apparatus in the first dimension to complete one step.

In some embodiments, in a scanning period in the second scanning direction, a scanning angle of the scanning group of the scanning module is α_{period}, and the horizontal detection angle of view in the second scanning direction is α_{FOV}, where in this case, α_{period} is greater than α_{FOV}. In some embodiments, when the scanning apparatus in the first direction is used as the apparatus for implementing the step size, the inter-group interval δβ can be obtained through a scanning angle of view of a scanning surface in the second scanning direction and the scanning speed of the second scanning surface. Ideally, a formula for calculating the inter-group interval also is:

$$δβ = \frac{{α}_{period}}{{ω}_{2}} {ω}_{1}$$

where δβ is the inter-group interval;
α_{period} is a scanning angle of the scanning group in one scanning period in the second scanning direction;
ω₁ is a first scanning speed in the first scanning direction; and
ω₂ is a second scanning speed in the second scanning direction.

In some embodiments, in one scanning period, a scanning angle α_{period} of the scanning group of the scanning module in the second scanning direction is greater than a horizontal detection angle of view α_{FOV} in the second scanning direction, that is, α_{period}>α_{FOV} That is, a specific angle is reserved for redundancy on the scanning module in the second direction, and a light emission module emits no light within the redundant angle, to avoid an uncontrollable outgoing laser beam and stray light in a cavity caused because there is surface curl on the scanning apparatus in the second scanning direction. Therefore, when the light emission module emits no light, the scanning module in the first direction can immediately rotate rapidly to implement the stepping of the scanning apparatus in this direction, and therefore, a formula for calculating the inter-group interval also is:

$$δβ = \frac{{α}_{period} - {α}_{FOV}}{{ω}_{2}} {ω}_{1}$$

where δβ is the inter-group interval;
α_{period} is a scanning angle of the scanning group in one scanning period in the second scanning direction;
α_{FOV} is a detection angle of view in the second scanning direction, and α_{period}>α_{FOV};
ω₁ is a first scanning speed in the first scanning direction; and
ω₂ is a second scanning speed in the second scanning direction.

The inter-group intervals in the foregoing embodiments are obtained by adjusting scanning step sizes of the scanning apparatus in the first scanning direction in the scanning module, and the scanning period is obtained through the scanning detection angle of view and scanning speed of the scanning apparatus in the second scanning direction, which facilitates a more proper arrangement form of a detection point cloud of the LiDAR and facilitates data processing of the LiDAR.

In some embodiments, when the scanning module scans another preset sub-region after leaving one preset sub-region, and scanning densities of the two preset sub-regions change greatly, change time of the step size can be increased by adding the redundant angle of the scanning apparatus in the second direction. For example, if the scanning apparatus in the second direction is a polygonal rotating mirror, change time of the inter-group interval can be increased by adding a void scanning surface of the polygonal rotating mirror, so that a scanning speed of the scanning module changes uniformly to the maximum extent, to reduce motion vibration of the scanning apparatus in the first direction that is caused by the speed change, and maintain stability of scanning movement of the scanning apparatus in the first direction. A formula for calculating the inter-group interval also is:

$$δβ = \frac{{α}_{period} - {α}_{FOV} + k α}{{ω}_{2}} {ω}_{1}$$

where δβ is the inter-group interval;
α_{period} is a scanning angle of the scanning group in one scanning period in the second scanning direction;
α_{FOV} is a detection angle of view in the second scanning direction;
α is an angle of view corresponding to each surface of a polygonal rotating mirror;
k is the number of surfaces of the polygonal rotating mirror;
α₁ is a first scanning speed in the first scanning direction; and
α₂ is a second scanning speed in the second scanning direction.

In another scanning mode of the LiDAR, the scanning module can also perform scanning in the following manner.

The polygonal rotating mirror can be a regularly-shaped rotating mirror or an irregularly-shaped rotating mirror. The regularly-shaped rotating mirror is a rotating mirror whose central angles corresponding to all surfaces are equal. The irregularly-shaped rotating mirror is a rotating mirror that has at least one surface whose corresponding central angle is unequal to another central angle corresponding to another surface.

The void scanning surface and magnitude of the central angle corresponding to the scanning surface of the scanning apparatus in the second direction are set to uniformize the scanning speed change of the scanning apparatus in the first direction to the maximum extent, thereby ensuring movement stability of the scanning apparatus in the first dimension.

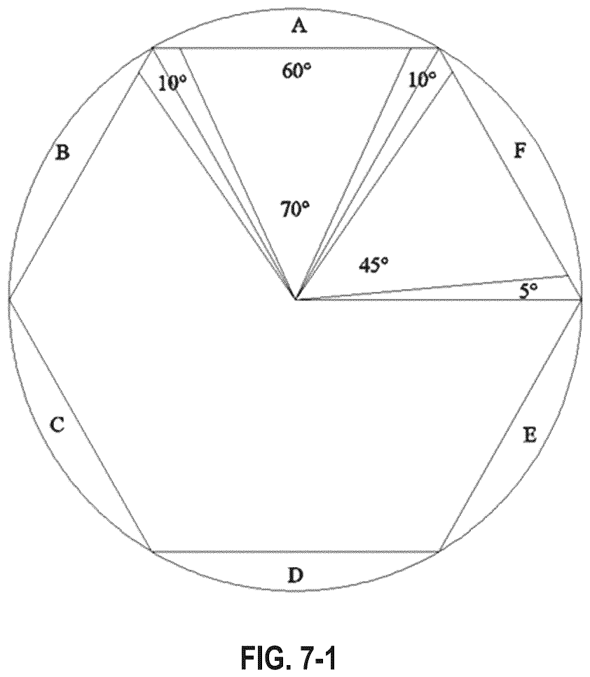

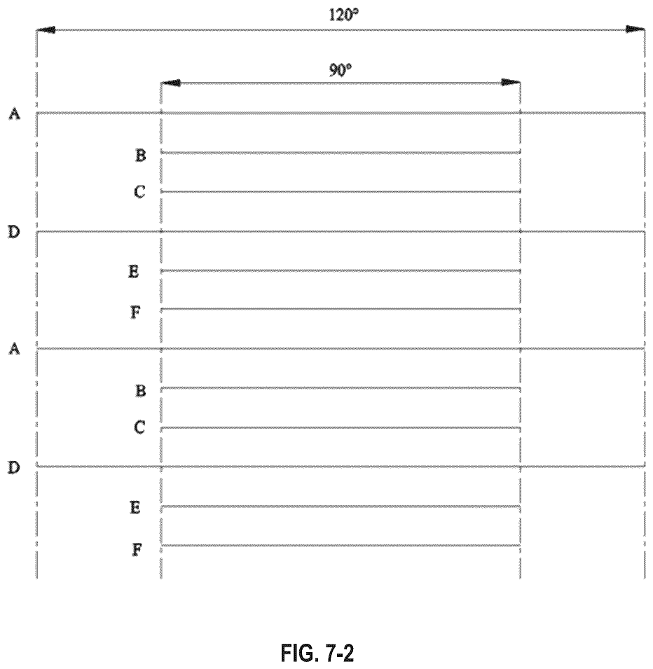

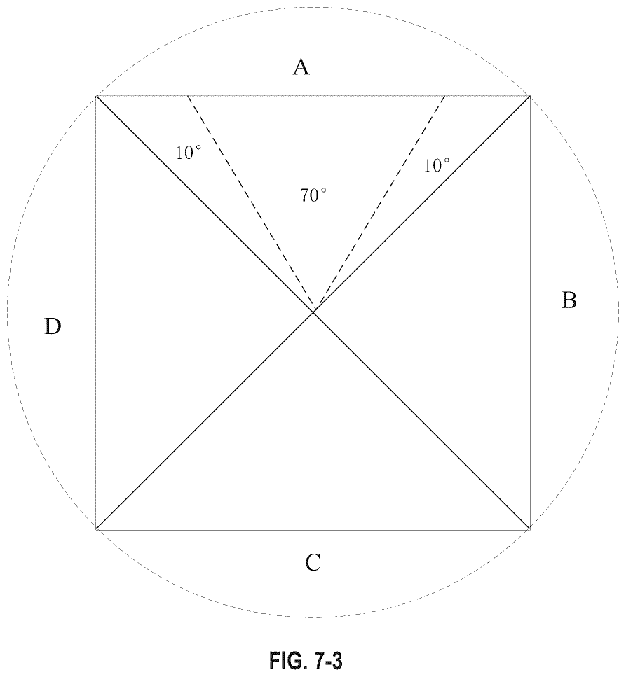

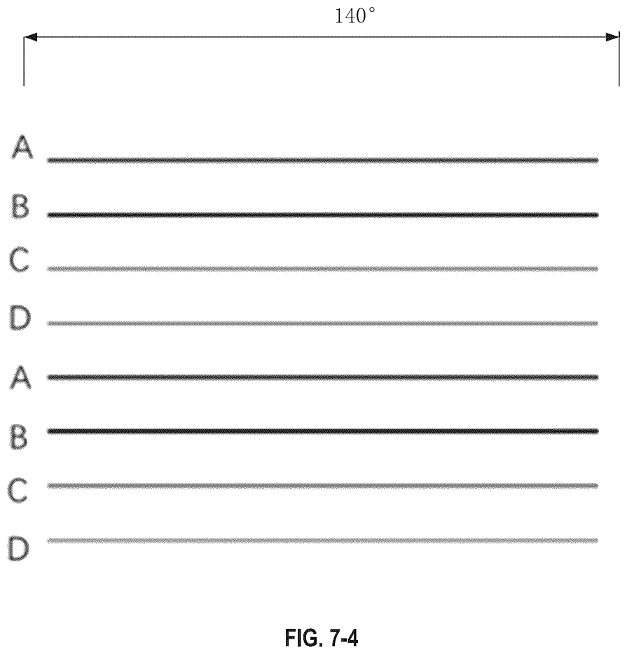

FIG. 7-1 is a schematic diagram of a cross section of an irregularly-shaped six-sided mirror. Surface A and surface D are the first scanning surfaces, and have the same divergence angle corresponding to the center of the rotating mirror, and surface B, surface C, surface D, and surface E are the second scanning surfaces, and have the same divergence angle corresponding to the center of the rotating mirror. In consideration of width of the beam, a redundant angle of 10 degrees is set, with 5 degrees for left and right sides.

As shown in FIG. 7-2, surface A corresponds to the largest detection field of view, that is, the total detection field of view, and the angle of view is 120 degrees. Therefore, it can be determined that the divergence angle of surface A corresponding to the center of the rotating mirror is 120/2+10=70 degrees. Herein, 60 degrees are used for scanning. Similarly, the divergence angle of the surface D corresponding to the center of the rotating mirror is degrees. The surface F corresponds to the detection angle of view of one preset sub-region. It can be seen that the angle of view corresponding to surface F is 90 degrees, and a divergence angle of surface F corresponding to the center of the rotating mirror is 55 degrees. Similarly, the divergence angles of the surfaces B, C, E, and F corresponding to the center of the rotating mirror are all 55 degrees. It can be understood that irregularly-shaped rotating mirrors herein are arranged symmetrically along a central axis to ensure stability of scanning rotation.

FIG. 7-3 is a schematic diagram of a cross section of a regularly-shaped four-sided mirror. Surface A, surface B, surface C, and surface D have the same divergence angle of degrees corresponding to the center of the rotating mirror. In consideration of the width of a light beam, as shown in FIG. 7-4, a redundant angle of 20 degrees is set, with 10 degrees for either of left side or right side, and therefore, a total detection angle of view is 140 degrees.

The redundant angle corresponding to the scanning surface is related to a size of the light spot and a proportion of the light spot to the entire scanning surface. The larger the light spot, the larger the set redundant angle; and the larger the proportion of the light spot to the entire scanning surface, the larger the redundant angle that needs to be set. Interference from stray light in a cavity can be better reduced by setting a proper redundant angle.

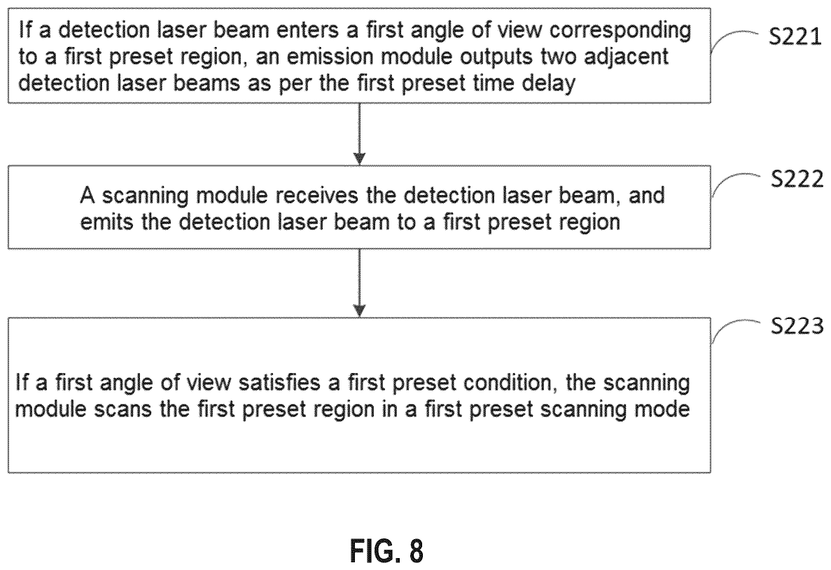

In some embodiments, as shown in FIG. 8, receiving, by a scanning module, the detection laser beam and emitting the detection laser beam to a preset region, and scanning, by the scanning module, the preset region in a preset scanning mode corresponding to the preset region includes the following steps.

S221. If a detection laser beam enters a first angle of view corresponding to a first preset region, an emission module outputs two adjacent detection laser beams as per the first preset time delay.

The first angle of view is set to an angle value within the first detection angle of view range corresponding to the first preset region. If the detection laser beam enters the first angle of view, that is, the detection laser beam enters the first preset region in the region of interest, in the preset region, the emission module outputs two adjacent detection laser beams as per the first preset time delay, so that the LiDAR outputs two adjacent detection laser beams as per different preset time delay in the new scenario, which changes the scanning resolution and improves flexibility of the scanning resolution of the LiDAR.

In some embodiments, when the scanning module scans the first preset region, the emission module switches from original preset time delay T₀ to first preset time delay T₁ to output two adjacent detection laser beams. The original preset time delay T₀ is greater than the first preset time delay T₁; or the original preset time delay T₀ is equal to the first preset time delay T₁. If the first preset time delay T₁ is less than the original preset time delay T₀, the detection laser beam scanning lines corresponding to the first preset region are denser than before, which improves the scanning resolution for the first preset region and improves the detection capability of the LiDAR. If the first preset time delay T₁ is equal to the original preset time delay T₀, the scanning resolution of the LiDAR remains unchanged. A specific value of the first preset time delay T₁ is not limited in embodiments of this application and can be set based on the scanning resolution required in actual application.

S222. A scanning module receives the detection laser beam, and emits the detection laser beam to a first preset region.

S223. If a first angle of view satisfies a first preset condition, the scanning module scans the first preset region in a first preset scanning mode, where the preset scanning mode includes the first preset scanning mode, and the preset condition includes the first preset condition.

In some embodiments, the first preset condition is that the first angle of view is less than or equal to a detection angle of view. Because the region of interest is generally less than or equal to the preset region, the first angle of view corresponding to the first preset region is also less than or equal to the detection angle of view. How to specifically obtain the first preset region and the first angle of view is not limited in embodiments of this application, and is set based on the scanning requirement for the LiDAR.

In some embodiments, an angle range of the first angle of view accounts for a preset ratio of the angle range of the detection angle of view. In some embodiments, the preset ratio is less than or equal to 50%. For example, the preset ratio is 50%, and if the angle range of the horizontal detection angle of view in the detection angle of view is −60° to 60°, the angle range of the horizontal detection angle of view in the first angle of view is −30° to 30°. For another example, the preset ratio is 36%, if the angle range of the vertical detection angle of view in the detection angle of view is −12.5° to 12.5°, the angle range of the vertical detection angle of view in the first angle of view is −4.5° to 4.5°. In some embodiments, the preset ratio is not specifically limited. For example, the preset ratio can also be 30%, 45%, 60%, 75%, or the like. A specific parameter setting is made based on the scanning resolution of the scanning module with respect to the first preset region.

In some embodiments, the first preset scanning mode is that the scanning group scans the first preset region with a first preset step size, and the scanning group is N scanning lines formed by the detection laser beams emitted by the emission module at a time, where N is an integer.

In some embodiments, as shown in FIG. 5, the first preset step size is

$$\frac{N}{n 1} \times δ θ ,$$

where n1 is a positive integer indivisible by N and n1<N, and δθ is a scanning angle interval between scanning lines in the scanning group. The scanning module scans the first preset region in the first preset scanning mode with the first preset step size of

$$\frac{N}{n 1} \times δ θ$$

to obtain the echo laser beam from the first preset region. Compared with a fixed scanning mode, because the step size changes along with the scanning density n1, the receiving module can obtain echo laser beam information that matches a scanning requirement for the first preset region, and after the echo laser beam information is processed, point cloud information of distance information, speed information, azimuth information, shape information and reflectivity information that matches the requirement for the first preset region is obtained.

In some embodiments, the first preset time delay T₁ is equal to the time required for the scanning group to complete the first preset step, so that if the detection laser beam enters the first angle of view corresponding to the first preset region, the emission module outputs two adjacent detection laser beams as per the first preset time delay T₁. Because the first preset step size of

$$\frac{N}{n 1} \times δ θ$$

is less than the fixed step size of N×δθ, and the step size in the first preset sub-region is greater than the step size in the second preset sub-region, if the same step time is used, that is, the same preset time delay is used, a step speed in the first preset sub-region is greater than a step speed in the second preset sub-region, and a step speed of a first scanning component changes significantly, which causes relatively large vibration for the scanning module, thereby affecting service life of the device. Therefore, controlling step time in a region with a large step size can effectively control a step speed in the region with a large step size, improve scanning stability of the scanning module, and prolong the service life of the scanning module.

As shown in FIG. 5, in some embodiments, the preset sub-region 62 with dense scanning lines is the first preset region in the region of interest. The same line type in the figure indicates that N detection laser beam scanning lines output by the emission module of the LiDAR at a time form a scanning group, and 4 line types indicate that the emission module outputs four groups of detection laser beam scanning groups A, B, C, and D in sequence in the vertical direction. The number of scanning lines in each scanning group is N, and an angle interval between the scanning lines is δθ. At moment t1, the scanning group A outputs a group A of N detection laser beam scanning lines at fixed frequency to scan from top to bottom, and the scanning module continues to scan downwards at a first preset step size of

$$\frac{N}{n 1} \times δ θ ;$$

at moment t2 when the scanning module completes the first preset step size of

$$\frac{N}{n 1} \times δ θ ,$$

the scanning group B outputs a group B of N detection laser beam scanning lines at fixed frequency to continue scanning from top to bottom; and at moment t3 when the scanning module completes the first preset step size of

$$\frac{N}{n 1} \times δ θ ,$$

the scanning group C outputs a group C of N detection laser beam scanning lines at fixed frequency to continue scanning from top to bottom until the entire spatial region is scanned, resolution of

$$\frac{δ θ}{n 1}$$

is formed in a region where middle scanning lines are overlapped, so that the scanning module in the LiDAR focuses on scanning of the first preset region of interest in the region of interest. Either time delay of the scanning module from the moment t1 to the moment t2 of completing the first preset step size of

$$\frac{N}{n 1} \times δ θ$$

or time delay of the scanning module from the moment t2 to the moment t3 of completing the first preset step size of

$$\frac{N}{n 1} \times δ θ$$

is first preset time delay T1.

In some embodiments, detection laser beams output by the emission module each time form a scanning group, and when the number of scanning lines in each scanning group is 4, the angle interval δθ between scanning lines is 0.1°. Assuming that a positive integer n1 indivisible by N is 3, each first preset step size of 4/3×0.1° of the scanning group is about 0.133°, resolution (0.1°/3=0.033°) can be implemented in the first preset region in the region of interest with dense scanning lines, and time required for the laser beam scanning line to complete the first preset step size of 0.133° is the first preset time delay T₁. Because the first preset time delay T₁ corresponds to the first preset step size of 0.133°, compared with the fixed time delay greater than the first preset time delay T₁, the LiDAR outputs denser scanning lines in the first preset scanning mode to the first preset region in the region of interest, so that denser echo laser beam information of the scanned region of interest is obtained, and after information carried in the echo laser beam is processed, more point cloud information of distance information, speed information, azimuth information, shape information and reflectivity information of the first preset region in the region of interest is obtained, thereby improving the scanning resolution of the LiDAR.

The number N of scanning lines of each scanning group, the angle interval δθ between the scanning lines, and a specific value of the positive integer n1 are not limited in embodiments of this application and can be set based on the scanning resolution required in actual application.

Position information of the first preset region in the region of interest and the position information of the preset region are not limited in embodiments of this application. For example, the position information of the first preset region in the region of interest may include coordinates of boundary points of the region of interest, and the position information of the preset region scanned via the laser beam may include coordinates of boundary points of the preset region scanned via the laser beam.

In the foregoing embodiments, when the detection laser beam enters the first preset region in the region of interest, the emission module outputs two adjacent detection laser beams as per the first preset time delay T₁, and the scanning module scans the first preset region in a first preset scanning mode with the first preset step size, which can improve the scanning resolution for the first preset region and improve detection capability for the first preset region, but does not resolve a technical problem of further improving the scanning resolution of the LiDAR for a more important region in the first preset region.

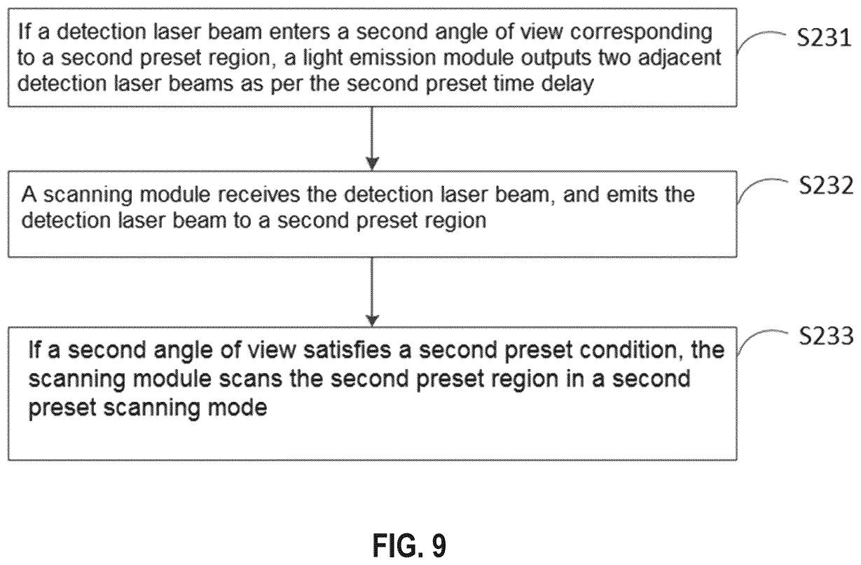

In some embodiments, as shown in FIG. 9, receiving, by a scanning module, the detection laser beam and emitting the detection laser beam to a preset region, and scanning, by the scanning module, the preset region in a preset scanning mode corresponding to the preset region further includes the following steps.

S231. If a detection laser beam enters a second angle of view corresponding to a second preset region, an emission module outputs two adjacent detection laser beams as per the second preset time delay, where second preset time delay is shorter than first preset time delay.

S232. A scanning module receives the detection laser beam, and emits the detection laser beam to a second preset region.

S233. If a second angle of view satisfies a second preset condition, the scanning module scans the second preset region in a second preset scanning mode, where the preset scanning mode includes the second preset scanning mode, and the preset condition includes the second preset condition.

In some embodiments, the second preset condition is that the second angle of view is less than the first angle of view, the second preset scanning mode is that the scanning group scans second preset regions with a second preset step size in sequence, and the scanning group is N scanning lines formed by the detection laser beams emitted by the emission module at a time, where N is an integer. The second preset step size is

$$\frac{N}{n 2} \times δ θ ,$$

where n2 is an integer indivisible by N and n1<n2<N, and δθ is a scanning angle interval between scanning lines.

In some embodiments, as shown in FIG. 5, a region with scanning lines denser than those in the preset sub-region 62 with dense scanning lines is the second preset region (not shown in the figure), the second preset step size is

$$\frac{N}{n 2} \times δ θ ,$$

where n2 is a positive integer indivisible by N and n1<n2<N, and δθ is a scanning angle interval between scanning lines in the scanning group. The scanning module scans the second preset region in the second preset scanning mode with the second preset step size of

$$\frac{N}{n 2} \times δ θ$$

to obtain the echo laser beam from the second preset region. Compared with the first preset scanning mode, because the second preset step size is less than the first step size of

$$\frac{N}{n 1} \times δ θ ,$$

the scanning module emits more detection laser beams than those in the first scanning mode to scan the second preset region, so that denser echo laser beam information of the second preset region can be obtained, and after the echo laser beam information is processed, more point cloud information of distance information, speed information, azimuth information, shape information and reflectivity information of the second preset region is obtained.

In some embodiments, the second preset time delay T₂ is equal to the time required for the scanning group to complete the second preset step, so that if the detection laser beam enters the second angle of view corresponding to the second preset region, the emission module outputs two adjacent detection laser beams as per the second preset time delay T₂. Because the second preset step size

$$\frac{N}{n 2} \times δ θ$$

is less than the first step size

$$\frac{N}{n 1} \times δ θ ,$$

the second preset time delay T₂ is less than the first preset time delay T₁. When the emission module outputs two adjacent detection laser beams as per the second preset time delay T₂, the LiDAR outputs two adjacent detection laser beams as per smaller time delay when scanning the second preset region, thereby improving the scanning resolution and the detection capability of the LiDAR.

In addition, when the LiDAR uses a principle of direct detection to detect a laser beam reflected back from an object, because the preset regions scanned via the laser beams are overlapped, the preset region scanned via the laser beam cannot correspond to a receiving and detection module, signal crosstalk occurs between the echo laser beams, and information carried in the echo laser beams subjected to crosstalk becomes pseudo point cloud information after being processed, thereby forming a pseudo target.

In some embodiments, the preset step size needs to be lower than a crosstalk angle range in each application scenario. In this way, when there is optical signal crosstalk between echo laser beams reflected by a short-distance target moving at a high speed, a single crosstalk phenomenon only affects a scanning range of the same group of scanning lines, which reduces impact of crosstalk on the LiDAR and avoids multiple occurrences of pseudo targets, thereby improving the resolution of the LiDAR in the spatial region and preventing a traffic accident caused by misjudgment.

In some embodiments, the crosstalk angle range in each application scenario is set to be less than or equal to 2°, that is, the angle interval δθ between the scanning lines is set to be less than or equal to 0.2°, which can improve an anti-crosstalk capability of the LiDAR and further improve the detection capability of the LiDAR.

In some embodiments, the angle interval between the scanning lines is set to 0.2°, and a solution for combining scanning lines of the LiDAR is as follows: there are 128 scanning lines, 8 scanning groups are arranged, 8 groups of scanning lines form a spatial region of 1.6°, and each group performs 16 scans. That is, when each emission module outputs a detection laser beam at a time to complete an entire frame of scanning period across the horizontal field of view or vertical field of view, a frame of point cloud image is formed. The spatial region corresponding to this frame of point cloud image is 1.6°. That is, within the spatial region of 1.6°, the detection laser beams output by the emission module of the LiDAR form 16 detection laser beam scanning lines at one time.

In some embodiments, the angle interval between the scanning lines is set to 0.1°, and a solution for combining scanning lines of the LiDAR is as follows: there are 256 scanning lines, 16 scanning groups are arranged, 16 groups of scanning lines form a spatial region of 1.6°, and each group performs 16 scans. That is, when each emission module outputs a detection laser beam at a time to complete an entire frame of scanning period across the horizontal field of view or vertical field of view, a frame of point cloud image is formed. The spatial region corresponding to this frame of point cloud image is 1.6°. Within the spatial region of 1.6°, the detection laser beams output by the emission module of the LiDAR form 16 detection laser beam scanning lines at one time.

In some embodiments, the angle interval between the scanning lines is set to 0.1°, and a solution for combining scanning lines of the LiDAR is as follows: there are 260 scanning lines, 20 scanning groups are arranged, 20 groups of scanning lines form a spatial region of 2.0°, and each group performs 13 scans. That is, when each emission module outputs a detection laser beam at a time to complete an entire frame of scanning period across the horizontal field of view or vertical field of view, a frame of point cloud image is formed. The spatial region corresponding to this frame of point cloud image is 1.6°. Within the spatial region of 1.6°, the detection laser beams output by the emission module of the LiDAR at a time form 13 detection laser beam scanning lines.

Only the time interval between two adjacent emissions of the same emission group is set in this application, and a time interval between two non-adjacent emissions of the same emission group is not specifically limited. The total number of scanning lines is not specifically limited yet, the angle interval between the scanning lines is not specifically limited yet, and the range of the spatial region in each frame of cloud image is not specifically limited yet, which are correspondingly set based on a detection requirement for the LiDAR in a specific embodiment.

In some embodiments, when the number N of scanning lines in each scanning group is 4, and the angle interval δθ between the scanning lines is 0.1°, the fixed step size 4×0.1° of the scanning group each time is approximately 0.4°, resolution of 0.1° can also be implemented in another preset region with sparse scanning lines. The scanning module scans another preset region other than the region of interest in a fixed scanning mode to obtain an echo laser beam from another preset region, obtain relatively sparse echo laser beams from another preset region, and obtain less point cloud information of distance information, speed information, azimuth information, shape information, and reflectivity information from another preset region after the information carried in the echo laser beams is processed, which can reduce the power of the LiDAR when another preset region other than the region of interest is scanned, and reduce an amount of data processed by the LiDAR, thereby saving energy consumed by the LiDAR.

S300. A receiving and detection module receives the echo laser beam and converts the echo laser beam into an electrical signal.

In some embodiments, the receiving and detection module receives the reflected echo laser beam, and converts the echo laser beam signal into an electrical signal that can be easily processed.

S400. A signal collection and processing module collects the electrical signal, and processes the electrical signal to obtain detection information of the preset region.

In some embodiments, the signal collection and processing module collects the electrical signal output by the receiving and detection module, and processes the electrical signal to obtain at least one type of information in the distance information, speed information, azimuth information, shape information, and reflectivity information of the preset region, and combines the information into point cloud information, thereby improving the detection capability of the LiDAR in various application scenarios.

Based on the LiDAR detection method provided in some embodiments, the emission module outputs two adjacent detection laser beams as per the preset time delay; the region corresponding to the detection field of view of the LiDAR is set as the preset region; the preset region is scanned in the preset scanning mode corresponding to the preset region; the scanning module also receives the echo laser beam reflected from the preset region and outputs the echo laser beam; the receiving and detection module receives the echo laser beam and converts the echo laser beam into an electrical signal; and the signal collection and processing module collects the electrical signal, and processes the electrical signal to obtain detection information of the preset region, to obtain a scanning point cloud of high density in the preset region and obtain more point cloud detection information, thereby improving scanning resolution of the LiDAR for the preset region, improving scanning flexibility of the LiDAR for different preset regions, and further improving detection capabilities of the LiDAR in different application scenarios.

In another scanning mode, because the preset time delay is less than the fixed time delay, and resolution in the preset scanning mode is higher than that in the fixed scanning mode, a scanning point cloud of higher density for the preset region can be obtained, to obtain more point cloud detection information, thereby improving the scanning resolution of the LiDAR with respect to the preset region, improving scanning flexibility of the LiDAR with respect to different preset regions, and improving the detection capabilities of the LiDAR in different application scenarios.

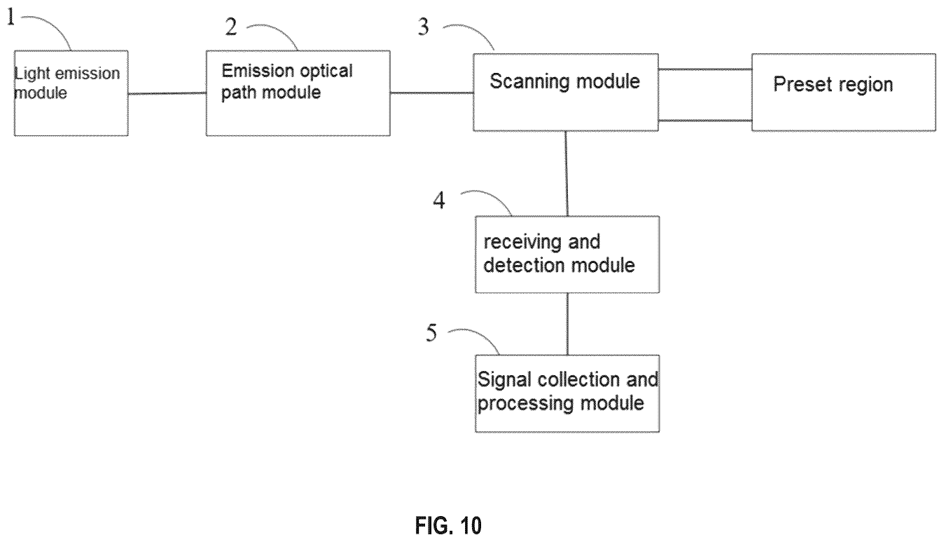

As shown in FIG. 10, a second aspect of the embodiments of this application further provides a LiDAR detection apparatus, including: an emission module 1, configured to output two adjacent detection laser beams as per preset time delay; an emission optical path module 2, configured to receive the detection laser beam and output the detection laser beam; a scanning module 3, configured to receive the detection laser beam, emit the detection laser beam to a preset region, and scan the preset region in a preset scanning mode corresponding to the preset region, and further configured to receive an echo laser beam reflected from the preset region and output the echo laser beam; a receiving and detection module 4, configured to receive the echo laser beam and convert the echo laser beam into an electrical signal; and a signal collection and processing module 5, configured to collect the electrical signal, and process the electrical signal to obtain detection information of the preset region.

Other components included in the LiDAR and the name of each component in the LiDAR are not limited in embodiments of this application. The application scenario of the LiDAR is not limited in embodiments of this application. For example, the LiDAR may be applied to fields such as smart transportation, autonomous driving, assisted driving, navigation, surveying and mapping, meteorology, aviation, or robotics, to implement space scanning, obstacle avoidance, route planning, weather forecasting, and the like.

In some embodiments, the emission group in the emission module is a light source. Improving the output signal-to-noise ratio of the LiDAR can improve a ranging range of the LiDAR, which is different from the prior-art LiDAR whose ranging range is improved by increasing the emission power of the LiDAR and whose resolution is improved by increasing the number of scanning line channels. In some embodiments, based on the formula of the output signal-to-noise ratio of the LiDAR, if the emission power of the LiDAR remains unchanged, the number of scanning line channels remains unchanged (that is, a channel coefficient remains unchanged), and an area of the receiving reflector remains unchanged, a light source interval between the light sources in the horizontal and vertical directions is reduced, divergence angles of the detection laser beams in the horizontal and vertical directions are reduced, the angle power of the light source is reduced, and power density of the light source is improved to improve the output signal-to-noise ratio of the LiDAR, thereby improving the ranging range and the ranging capability of the LiDAR. In addition, power consumption of the entire LiDAR is also reduced, which facilitates environmental protection and energy saving, also reduces a heat dissipation requirement and improves reliability of the entire LiDAR.

A formula of an output signal-to-noise ratio of the LiDAR is:

$$SNR ∝ \frac{{P}_{t}}{\sqrt{δ {θ}_{x} \times δ {θ}_{y}}} \times \sqrt{{S}_{mirror} - {C}_{channel} \times {P}_{θ} \times \frac{{θ}_{divx} \times {θ}_{divy}}{{P}_{density}}}$$

where SNR is the output signal-to-noise ratio of the LiDAR;
Pₜ is the emission power of the LiDAR;
Sₘᵢᵣᵣₒᵣ is an area of a receiving reflector;
P_{θ} is angle power of the light source;
δθₓ is the light source interval in the horizontal direction x;
δθ_{y} is the light source interval in the vertical direction y;
θ_{divx} is the divergence angle of the detection laser beam in the horizontal direction x;
θ_{divy} is the divergence angle of the detection laser beam in the vertical direction y;
P_{density} is power density of the light source; and
C_{channel} is a channel ratio coefficient of a multi-channel light spot and the single-channel light spot, where the more the channels, the larger the coefficient C_{channel}.

Based on the formula for calculating the divergence angle, the divergence angles of the detection laser beams in the horizontal and vertical directions can be reduced by reducing the luminous area of the light source and by increasing the equivalent focal length of the emission optical path module of the LiDAR. Based on the formula for calculating a scanning line channel interval (also referred to as the scanning line interval), the scanning line interval can be reduced by increasing the equivalent focal length of the emission optical path module of the LiDAR and by reducing the light source interval between the light sources.

A formula for calculating the divergence angle is:

θ_{div}=L/f
where θ_{div} is the divergence angle of the detection laser beam in the horizontal or vertical direction;
f is equivalent focal length of an emission optical path module of the LiDAR; and
L is the length or width of the light source.

A formula for calculating the scanning line interval is:

$$α = \frac{δ θ}{f}$$

where α is the scanning line interval;
f is equivalent focal length of an emission optical path module of the LiDAR; and
δθ is a light source interval between light sources in the horizontal or vertical direction.

In some embodiments, the horizontal direction refers to a left-right direction relative to the target object in the spatial region, and the vertical direction refers to an up-down direction relative to the target object in the spatial region.

In some embodiments, the emission module 1 includes at least two light sources and a drive module for driving each light source to output a detection laser beam as per preset time delay. When the LiDAR detects the target region, the drive module is configured to drive multiple light sources in an emission module 1 to output detection laser beams as per preset time delay. In some embodiments, length or width L of a light emission source is less than or equal to 0.2 mm, or further, the length or width L of the light emission source is less than or equal to 0.1 mm; and a preset light source interval δθ between light sources in the horizontal or vertical direction is less than or equal to 0.4 mm, or further, a preset light source interval δθ between light sources in the horizontal or vertical direction is less than or equal to 0.1 mm.

In some embodiments, the at least two light sources in the emission module 1 are distributed on a straight line at intervals of the preset light source interval, a plane where a light source line is located is perpendicular to a normal line of the light emission direction of the light source, and a direction perpendicular to the direction of the straight line is the up-down direction relative to the target object in the spatial region. Disposing the light source in the vertical direction facilitates an increase in the scanning speed of the LiDAR in the horizontal scanning direction and expands the scanning field of view in the vertical direction.

In some embodiments, the light source is a power laser device, and the power laser device is at least one of an edge emitting laser (EEL) or Vertical-Cavity Surface-Emitting Laser (VCSEL). Output power of the high-power laser device is greater than or equal to 1000 W/mm2. The output power of the laser device is increased, so that the length or width of the light emission source can be reduced when the preset ranging range is satisfied, thereby reducing a luminous area of the light source, and further reducing the divergence angle of the detection laser beam.

In some embodiments, the power laser device can also form an array laser beam source, which can further reduce the light source interval between the light sources, further reduce the scanning line channel interval, and improve the resolution of the laser beam of the LiDAR.

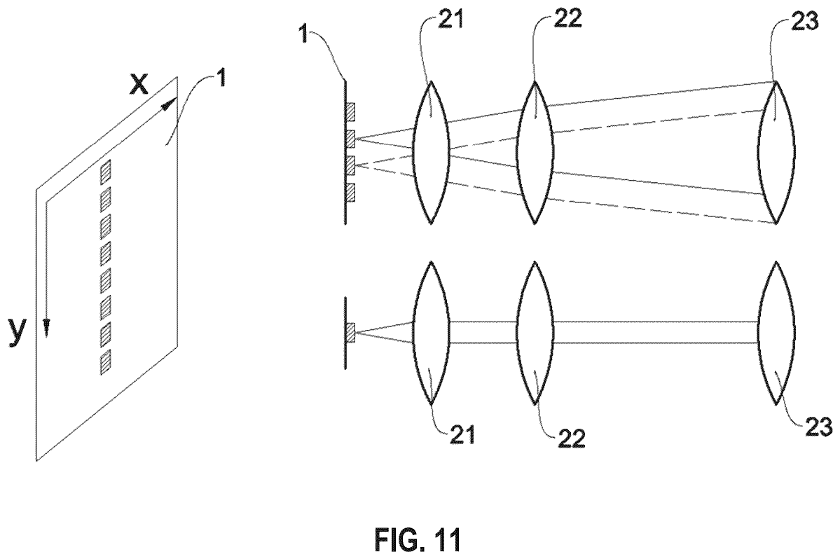

In some embodiments, as shown in FIG. 11, an emission lens includes a first lens 21, a second lens 22, and a third lens 23 that are coaxial.

The first lens 21 receives the detection laser beam, and converts a detection laser beam in a horizontal light emission direction in the detection laser beams into collimated light.

The second lens 22 receives the collimated light and transmits the collimated light to the third lens 23, and the second lens 22 also refracts a detection laser beam in a vertical light emission direction in the detection laser beams to the third lens 23.

The third lens 23 receives the collimated light and transmits the collimated light to the scanning module 3, and the third lens 23 also converts a detection laser beam in the vertical light emission direction in the detection laser beams into the collimated light and transmits the collimated light to the scanning module 3.

A design of the focal length formed by the second lens and the third lens can effectively reduce the divergence angle of the outgoing laser beam, so that the divergence angle θ_{div} of the detection laser beam in the horizontal or vertical direction and the scanning line interval α can be at the same order of magnitude, which can meet the requirement that the divergence angle θ_{div} of the detection laser beam is 0.1° and can also meet the requirement that the scanning line interval α is 0.1°.

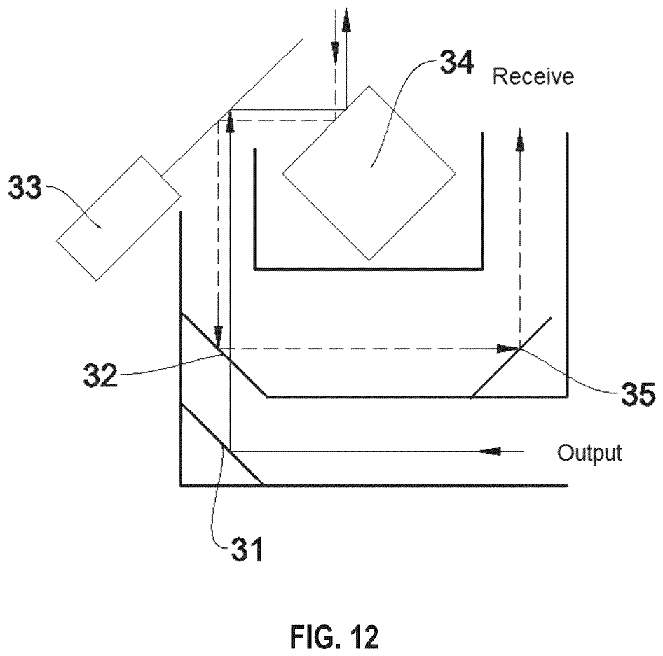

In some embodiments, as shown in FIG. 12, a LiDAR system includes an emission channel and a receiving channel. A first reflector 31 and a reflector 32 with a through hole are arranged in the emission channel. A reflector 32 with the through hole and a second reflector 35 are arranged in the receiving channel. A scanning module includes a one-dimensional galvanometer 33 in a first scanning direction and a rotating mirror 34 in a second scanning direction.

The outgoing laser beam is reflected by the first reflector 31, passes through the reflector 32 with a through hole, and is incident on the one-dimensional galvanometer 33. The one-dimensional galvanometer 33 deflects the outgoing laser beam to the rotating mirror 34, and the outgoing laser is reflected by the rotating mirror 34 to the detection field of view.

An echo laser beam is first deflected to the one-dimensional galvanometer 33 by the rotating mirror 34, deflected to the receiving channel by the one-dimensional galvanometer 33, and deflected to the second reflector 35 by the reflector 32 with a through hole, and the echo laser beam is deflected to the receiver by the second reflector 35, so that the receiver receives the echo laser beam.

The first reflector 31 and the reflector 32 with a through hole are disposed in the LiDAR system, so that an emission optical path of the LiDAR system forms a telephoto optical path, thereby reducing the far-field divergence angle of the outgoing laser beam and improving the detection capability. In addition, the reflector 32 with a through hole and the second reflector are disposed, so that a receiving optical path of the LiDAR system forms a telephoto optical path, thereby reducing the FOV on the receiving side, reducing noise interference on the receiving side, and further improving ranging. The scanning module of the LiDAR in some embodiments can implement resolution less than or equal to 0.1° and resolution less than or equal to 0.04° in the preset scanning mode corresponding to the preset time delay, which improves the detection capability for a far-field target and improves a detection capability for a ground line, thereby obtaining point cloud information with higher resolution from the spatial region and improving the resolution of the LiDAR for different regions.

In some embodiments, there is a single-emission multiple-reception correspondence between the emission device and the receiving devices of the LiDAR.

That is, one laser corresponds to multiple receiving detectors, and under the same resolution requirement, the number of receiving devices corresponding to one emission device is increased, the number of parallel emission channels corresponding to one emission is reduced, width of the light spot in the vertical direction is reduced, and therefore, an area of the through hole on the reflector 32 with the through hole is reduced, a receiving diameter is improved, and an area of the received light spot is increased, thereby facilitating improvement of the ranging performance. In addition, because the number of emission channels is reduced, design complexity of an optical path of the LiDAR is reduced, and costs are reduced. The light source interval between laser beam sources can be further reduced to reduce the interval between scanning lines, thereby reducing crosstalk caused by optical signals. Further, the receiving and detection module includes an array of Silicon Photomultipliers (SiPM). When 4 laser beam sources are arranged in the vertical direction, the corresponding array of Silicon Photomultipliers distributed in the vertical direction includes 8 silicon photomultiplier units, thereby realizing a single-emission dual-reception transceiver mode.

In the foregoing embodiments, the descriptions of the embodiments have respective focuses. For a part that is not described in detail in one embodiment, reference may be made to related descriptions in other embodiments.

The disclosed module and method may be implemented in other manners. For example, the embodiments of the described module are merely examples. For example, the module or unit division is merely logical function division and may be another division in actual implementation. For example, a plurality of units or components may be combined or integrated into another system, or some features may be ignored or not performed.

What is claimed is:

1. A detection method, comprising:
outputting, by an emission module, detection laser beams with a preset time delay between two adjacent emissions;
receiving, by a scanning module, the detection laser beams and emitting the detection laser beams to a preset region; scanning, by the scanning module, the preset region in a preset scanning mode; and further receiving, by the scanning module, an echo laser beam reflected from the preset region, and outputting the echo laser beam;
receiving, by a receiving and detection module, the echo laser beam and converting the echo laser beam into an electrical signal; and
collecting, by a signal collection and processing module, the electrical signal, and processing the electrical signal to obtain detection information of the preset region.

2. The detection method according to claim 1, wherein a scanning direction of the scanning module comprises at least one scanning direction in a first scanning direction and a second scanning direction, the first scanning direction and the second scanning direction form a preset angle, and the preset angle is less than or equal to 180 degrees; and
scanning, by the scanning module, the preset region in a preset scanning mode corresponding to the preset region further comprises:
scanning, by the scanning module, the preset region in the first scanning direction in the preset scanning mode corresponding to the preset region.

3. The detection method according to claim 1, wherein a scanning direction of the scanning module comprises at least one scanning direction in a first scanning direction and a second scanning direction, the first scanning direction and the second scanning direction form a preset angle, and the preset angle is less than or equal to 180 degrees; and
scanning, by the scanning module, the preset region in a preset scanning mode corresponding to the preset region further comprises:
scanning, by the scanning module, the preset region in the second scanning direction in the preset scanning mode corresponding to the preset region.

4. The detection method according to claim 2, wherein the preset region comprises at least one preset sub-region; and
before outputting, by the emission module, the detection laser beams with the preset time delay between two adjacent emissions, the detection method comprises:
obtaining, by a LiDAR, a scanning region corresponding to a detection angle of view of the scanning module;
obtaining, by the LiDAR, a preset sub-region in which the scanning region is located;
obtaining, by the LiDAR, a scanning density corresponding to the preset sub-region; and
based on the scanning density, controlling, by the LiDAR, the emission module to output a detection laser beam according to a preset time delay corresponding to the scanning density.

5. The detection method according to claim 4, wherein scanning, by the scanning module, the preset region in the preset scanning mode corresponding to the preset region comprises:
obtaining, by the scanning module, the preset scanning mode corresponding to the scanning density; and
scanning, by the scanning module, the preset sub-region in the preset scanning mode.

6. The detection method according to claim 5, wherein
the preset scanning mode is to scan the preset sub-region by using an inter-group interval of scanning groups corresponding to the preset sub-region, the scanning group comprises N scanning lines formed by detection laser beams emitted by the emission module at a time, and the inter-group interval is an inter-group angle interval between scanning groups during two adjacent emissions; and
a formula for calculating the inter-group interval is:
δB=N/nδθ
wherein δβ is the inter-group interval;
δθ is an angle interval between scanning lines in the scanning group;
N is the number of scanning lines in each scanning group, and N is an integer; and
n is a densification multiple of the scanning line corresponding to the preset sub-region, n is a real number and n is greater than or equal to zero.

7. The detection method according to claim 5, wherein
the preset scanning mode is also to scan the preset sub-region at a scanning speed of scanning groups corresponding to the preset sub-region, and determine the scanning speed corresponding to the preset sub-region based on the preset time delay, an inter-group interval, and both the preset time delay and the inter-group interval, wherein the scanning group comprises N scanning lines formed by detection laser beams emitted by the emission module at one time, N is an integer, and the inter-group interval is an inter-group angle interval between scanning groups during two adjacent emissions.

8. The detection method according to claim 7, wherein
a formula for calculating the inter-group interval further is:
$$δβ = \frac{{α}_{period} - {α}_{F O V}}{{ω}_{2}} {ω}_{1}$$
wherein δβ is the inter-group interval;
α_{period} is a scanning angle of the scanning group in one scanning period in the second scanning direction;
α_{FOV} is a detection angle of view in the second scanning direction, and α_{period}>α_{FOV};
ω₁ is a first scanning speed in the first scanning direction; and
ω₂ is a second scanning speed in the second scanning direction.

9. The detection method according to claim 1, wherein the emission module comprises at least one emission group; and
outputting, by the emission module, the detection laser beams with the preset time delay between two adjacent emissions comprises:
outputting, by the same emission group of the emission module, the detection laser beams with the preset time delay between two adjacent emissions; or
outputting, by each emission group of the emission module, the detection laser beams with the preset time delay between two adjacent emissions.

10. A LiDAR detection apparatus, comprising:
an emission module, configured to output detection laser beams with a preset time delay between two adjacent emissions;
an emission optical path module, configured to receive the detection laser beams and output the detection laser beams;
a scanning module, configured to receive the detection laser beams and emit the detection laser beams to a preset region, scan the preset region in a preset scanning mode, and further receive an echo laser beam reflected from the preset region and output the echo laser beam;
a receiving and detection module, configured to receive the echo laser beam and convert the echo laser beam into an electrical signal; and
a signal collection and processing module, configured to collect the electrical signal, and process the electrical signal to obtain detection information of the preset region.

11. The LiDAR detection apparatus according to claim 10, wherein
the emission optical path module comprises a first lens, a second lens, and a third lens that are coaxial, wherein
the first lens receives the detection laser beam output by the emission module, and converts a detection laser beam in a horizontal light emission direction in the detection laser beams into collimated light;
the second lens receives the collimated light and transmits the collimated light to the third lens, and the second lens also refracts a detection laser beam in a vertical light emission direction in the detection laser beams to the third lens;
the third lens receives the collimated light and transmits the collimated light to the scanning module, and the third lens also converts a detection laser beam in the vertical light emission direction in the detection laser beams into the collimated light and transmits the collimated light to the scanning module;
the second lens and the third lens form a telephoto optical path; and
equivalent focal length of the telephoto optical path is greater than or equal to 50 mm.
